(19) United States
(12) Patent Application Publication
(10) Pub. No.: US 2012/0170043 A1
(43) Pub. Date: Jul. 5, 2012

(54) Sensitive and Compact Sensor Employing a Visible Diode Laser and A High Finesse Optical Cavity for Trace Gas Detection (NO2)

(75) Inventor: Gottipaty Rao, West Hempstead, NY (US)

(73) Assignee: Adelphi University, Garden City, NY (US)

(21) Appl. No.: 13/371,075

(22) Filed: Feb. 10, 2012

Related U.S. Application Data
(63) Continuation-in-part of application No. 13/025,991, filed on Feb. 11, 2011.
Application No. 13/025,991 is a continuation-in-part of application No. 13/026,011, filed on Feb. 11, 2011, now Pat. No. 8,149,407.
Application No. 13/026,011 is a continuation-in-part of application No. 12/878,553, filed on Sep. 9, 2010.

(51) Int. Cl. G01N 21/59

(52) U.S. Cl. 356/437

(57) ABSTRACT

A sensor with high sensitivity and selectivity for the detection of NO₂ uses a simple diode laser operating nominally at 405 nm in the visible region, a high finesse optical cavity and a low noise photon detector. The sensor employs the multimode broad output of the diode laser with the high finesse optical cavity in an essentially off-axis arrangement that can provide large path lengths of the order of a km in a small volume cell. The detected absorption signal corresponds to multiple line integrated absorption spectroscopy (MLIS). Because the sensor uses visible radiation it can employ optics in the visible region that are normally less expensive. Also, the sensor is free from interference from atmospheric water vapor which is often a severe problem for sensors based on mid-infrared quantum cascade lasers operating in the mid-infrared (for example 1650 cm⁻¹) region.

### RELATED APPLICATION

This application is a continuation-in-part of U.S. patent application Ser. No. 13/025,991 and Ser. No. 13/026,011, both filed Feb. 11, 2011, and is a continuation-in-part of U.S. patent application Ser. No. 12/878,553 filed Sep. 9, 2010. Priority is claimed from those applications and their contents are incorporated herein by reference.

### BACKGROUND OF THE INVENTION

The present invention relates to the detection of trace gases emanating from improvised and regular explosives, trace gases produced in the combustion processes, trace gases in the atmosphere and automobile exhaust with high sensitivity and selectivity and, more particularly, to employing tunable and non-tunable diode lasers for trace detection of nitrogen dioxide.

The real-time detection of trace gases in the parts-per-billion (ppb or 10⁹) and parts-per-trillion (ppt or 10¹²) levels is of great interest in a wide range of fields, including environmental science and air quality control (e.g., for compliance with Environmental Protection Agency regulations), defense and homeland security (e.g., for the detection of trace amounts of explosive compounds), medical diagnostics, detecting trace impurities in the semiconductor industry, and optimizing combustion processes and minimizing pollution emissions, to name a few. See the following articles that describe these prior concerns: “Primary National Ambient Air Quality Standards for Nitrogen Dioxide; Final Rule,” Federal Register, Vol. 75, No. 26, 6474-6537, Feb. 9, 2010; United States Environmental Protection Agency, “National Air Quality Status and Trends Through 2007, EPA-454/R-08-006”, United States Environmental Protection Agency, Washington D.C., (2008); J. Hildenbrand, J. Herbst, J. Wollenstein, A. Lambrecht, “Explosive detection using infrared laser spectroscopy,” Proc. SPIE 7222, 72220B-1-72220B-12 (2009); and T. H. Risby, S. F. Solga, “Current status of clinical breath analysis,” Appl. Phys. B 85, 421-426 (2006).

Laser-based techniques are well suited for trace gas detection because of their ability to provide real-time monitoring capabilities with a high degree of sensitivity and selectivity. A simple, compact, rugged and reliable NO₂ monitor capable of high sensitivity and selectivity would be valuable for monitoring atmospheric air quality (to meet EPA air quality standards, and monitor the formation of photochemical smog, tropospheric ozone, and automobile and industrial emissions), as well as for the real-time study of the complex photochemical reactions that the NOₓ gases undergo in the atmosphere. See, A. Arnold, H. Becker, R. Hemberger, W. Hentschel, W. Ketterle, M. Kollner, W. Meienburg, P. Monkhouse, H. Neckel, M. Schafer, K. P. Schindler, V. Sick, R. Suntz, J. Wolfrum, “Laser in situ monitoring of combustion processes,” App. Opt., 29, 4860-4872 (1990). Such NO₂ monitor can also be used for the detection of improvised explosives based on nitrates (such as ammonium nitrate) and Nitro-aromatics (such as TNT) which have moderate vapor pressure at room temperature.

A variety of spectroscopic techniques have been developed for trace gas detection, each having its own merits and limitations. The spectroscopic techniques that are commonly employed include, absorption spectroscopy using long pass absorption cells such as multipass and Herriott cells, optical cavity methods (cavity ring-down spectroscopy, off-axis integrated cavity output spectroscopy), photo-acoustic and quartz-enhanced photo-acoustic spectroscopy, and Faraday rotation spectroscopy. Various data processing and analysis procedures have been applied such as frequency modulated spectroscopy techniques to improve the signal to noise ratio and multiple line integrated absorption spectroscopy to improve the sensitivity of detection. The current status of much of this work was presented in the recent review articles; F. K. Tittel, Y. Bakhirkin, A. Kosterev, G. Wysocki, “Recent Advances in Trace Gas Detection Using Quantum and Interband Cascade Lasers,” Rev. of Laser Eng. 34, 275-282 (2006); R. F. Curl, F. Capasso, C. Gmachl, A. A. Kosterev, B. McManus, R. Lewicki, M. Pusharsky, G. Wysocki, and F, K. Tittel, “Quantum cascade lasers in chemical physics” Chem. Phys. Lett. 487, 1-18 (2010); and the present inventor Gottipaty N. Rao, and A. Karpf, “External cavity tunable quantum cascade lasers and their applications to trace gas monitoring,” Appl. Opt. A100-A115 (2010).

Several of these techniques have severe limitations for field based detection applications. For example, multipass and Herriott cells are bulky and require high precision optical adjustments and stability, and therefore are not convenient for field based monitoring purposes. Cavity ring down spectroscopy offers excellent sensitivity and selectivity and internal calibration that will not need calibration standards, but requires cavity adjustments to achieve resonance condition and has severe limitations because it requires vibration isolation, and high precision optical resonance cavity arrangement.

Trace gas detection using laser absorption spectroscopy is based on recording the change in intensity of the laser radiation as it passes through a region containing the sample of interest. In this technique the laser is tuned across specific molecular transitions of interest, the spectra are synchronously added and averaged, and either compared with molecular cross-section data or secondary calibration procedures are employed to obtain the concentrations. In order to detect very low concentration species in the ppb level or lower, one would employ multi-pass cells to increase the path length and improve the sensitivity of detection. Using multipass optical cells, one can reach path lengths in hundreds of meters range; however, the volume of these cells is large (typically about 1 l). The main difficulty with multipath cells is that they are bulky, involve careful cavity adjustments and are sensitive to vibrations which are potential limitations for field applications. Fabry-Perot optical cavities provide long path lengths on the order of several km in a small effective volume. See, J. B. Paul, L. Lapson and J. G. Anderson, “Ultrasensitive absorption spectroscopy with a high-finesse optical cavity and off-axis alignment,” Appl. Opt. 40, 4904-4910 (2001); G. Berden, R. Peeters, G. Meijer, “Cavity ring-down spectroscopy: Experimental schemes and applications,” Int. Reviews in Physical Chemistry, Vol. 19, No. 4. 565-607 (2000); and the present inventor G. N. Rao and A. Karpf, “High sensitivity detection of NO₂ employing cavity ring-down spectroscopy and an external cavity continuously tunable quantum cascade laser,” Appl. Opt., 49, 4906-4914 (2010).

In a cavity-based detection technique, the laser is coupled to a high finesse optical cavity (formed by highly reflective, low-loss dielectric mirrors) so that a large amount of light energy builds up within the cavity. In cavity ring down spectroscopy (CRDS), one interrupts the laser beam and measures the exponential decay of the light exiting the cavity (cavity ring down time) with and without the gas sample. While, CRDS offers high sensitivity of detection and provides an absolute value of the absorption coefficient (i.e., no need for secondary calibration procedures), it is susceptible to vibrations and requires stringent cavity resonance conditions. An additional limitation to CRDS is its dependence on high-speed detection electronics due to the short time scale of most CRD decays. The off-axis integrated cavity output spectroscopy (OA-ICOS) typically provides path lengths on the order of a few km. In this technique, one aligns the laser in an off-axis configuration with the high finesse optical cavity to generate a high density of transverse cavity modes. Often, one dithers the cavity length and simultaneously modulates the laser to randomize the modes and record usable spectra. The OA-ICOS technique is particularly attractive for trace gas sensors because the system does not involve the complex cavity locking mechanisms or stringent resonance conditions necessary in CRDS experiments, is less sensitive to vibrations, and does not require high-speed electronics. The off-axis arrangement allows a range of laser input directions compared to a single normal incidence condition that is necessary for the cavity resonance condition. Therefore, the off-axis arrangement allows a certain level of freedom from the severe vibration isolation and cavity alignment requirements of the cavity resonance experiments such as CRDS.

In Multiple Line Integrated Absorption Spectroscopy (MLIAS) recently proposed by the inventor, instead of monitoring a single absorption peak as is traditionally done, the laser is scanned over a large number of molecular transitions and the sum of the areas of all the absorption peaks (after subtracting the background) are taken for sensitivity measurements. This technique improves the sensitivity of detection by an order of magnitude or more compared to the absorption measurements employing a single absorption peak. See, A. Karpf and Gottipaty N. Rao, “Enhanced Sensitivity for the Detection of Trace Gases Using Multiple Line Integrated Absorption Spectroscopy,” Applied Optics, 48, 5061-66, (2009).

### NO₂ Spectral Region of Interest

The absorption spectra of NO₂ in the ultraviolet and visible regions covering 250-800 nm have been extensively investigated and the corresponding absorption coefficients have been reported by several groups. See, S. Voigt, J. Orphal, and J. P. Burrows, “The temperature and pressure dependence of the absorption cross-sections of NO₂ in the 250-800 nm region measured by Fourier-transform spectroscopy,” J. Photochem. Photobiol. A: Chem. 149, 1-7 (2002); and K. Yoshino, J. R. Esmond, and W. H. Parkinson, “High-resolution absorption cross section measurements of NO₂ in the UV and visible region,” Chem. Phys. 221, 169-174 (1997). The cross-sections for the absorption in the region are high with a broad peak in the 350-450 nm range and a large number of intense sub-peaks extending over the entire 350-450 nm region. This region contains a strong, dense spectrum that is well suited for use in the trace detection of NO₂ using spectroscopic techniques. The values of the absorption cross-sections at the peak are of the same order of magnitude (7×10⁻¹⁹ cm²/mol) as the fundamental rotational-vibrational bands found at 1650 cm⁻¹. Considering various aspects as detailed later, the short-wavelength visible region is optimal for the development of an NO₂ sensor and is well suited for atmospheric environmental monitoring applications. In this region, high power diode lasers are currently available at 405±10 nm and 450±10 nm.

### Choice of the 405 nm Laser

Of the primary atmospheric components and trace gases that would be typically found in an outdoor setting, the following species have the potential for interference: H₂O, O₃, SO₂, NO₃ and OClO. Working in the 405 nm range avoids or greatly reduces the interference problems posed by all of these species, except for OClO. The potential for chlorine dioxide to cause interference is not yet fully understood, but is likely to be negligible due to the fact that it is normally found in cleaners used indoors, and is highly reactive (and thus is not likely to be stable enough to be found in meaningful quantities in outside air).

### Nitrogen Oxides

NO

There are no Nitric Oxide lines that occur in the near-UV and visible regions in which NO₂ has lines.

N₂O₄

Dinitrogen tetraoxide has strong absorption lines in the UV as well as moderately strong lines in the violet-blue range (395-455 nm)—the cross-sections of N₂O₄ are approximately 2 orders of magnitude weaker than the NO₂ lines in the same region and the concentrations of N₂O₄ in the atmosphere are expected to be low and therefore it is not expected to be of a problem.

NO₃

The Nitrate Radical (NO₃) has very strong absorption lines in visible region (400-700 nm). The cross-sections in this region can reach the low 10⁻¹⁶ cm²/mol at 600 nm. In the region at which NO₂ would be detected (405 nm), the NO₃ lines have cross-sections that are approximately equal to that of NO₂. The atmospheric concentration of NO₃, however, is expected to be 3 or more orders of magnitude lower than NO₂. See, R. Atkinson, D. L. Baulch, R. A. Cox, J. N. Crowley, R. F, Hampson, Jr., J. A. Kerr, M. J. Rossi, and J. Troe, “Summary of evaluated kinetic and photochemical data for atmospheric chemistry,” Web Version July 2004, update 16 Jul. 2001; and D. S. Venables, T Gherman, J. Orphal, J. C. Wenger, A. A. Ruth, “High sensitivity in situ monitoring of NO₃ in an atmospheric simulation chamber using incoherent broadband cavity-enhanced absorption spectroscopy,” Environ Sci Technol. 2006 Nov. 1; 40(21):6758-63.

### Primary Atmospheric Components

The potential of primary atmospheric components to interference with NO₂ detection was investigated for ambient air typical for the summer in the mid-latitude U.S. This involved the following concentrations of gases:

| Species | % Abundance | ppm |
|---|---|---|
| H₂O | 1.862987 | 18,630 |
| CO₂ | 0.032701 | 327 |
| N₂O | 0.000032 | 32 |
| CO | 0.000015 | 15 |
| CH₄ | 0.000168 | 168 |
| O₂ | 20.710864 | |
| N₂ | 77.393229 | |

### Water Vapor

Of the gases in the table above, only water vapor has lines in the vicinity of the regions in which NO₂ sensor operates. However, even though these lines are weak (the lines in the vicinity of the 450 nm diode (22500 cm⁻¹) have cross-sections ˜2×10⁻²⁷ cm²/mol), they could cause interference. The water lines are approximately 8 orders of magnitude weaker than NO₂ lines in the same region. However, there are approximately 10⁶ more H₂O molecules than NO₂ molecules in a typical sample. This means that the signal from water at ˜450 nm could climb to a couple percent of the strength of the NO₂ signal. On the other hand, there are no water lines around the 405 nm region (24400 cm⁻¹)—thus making this a better region for NO₂ detection. See, C. N. Mikhailenko, Yu, L. Babikov, and V. F. Golovko, “Information-calculating system Spectroscopy of Atmospheric Gases. The structure and main functions,” Atmos, Oceanic Opt, 18, 685-695 (2005).

### Trace Gases

As per the Clean Air Act requirements the EPA set limits (National Ambient Air Quality Standards) for six common air pollutants. These are: particulate matter, ground-level ozone, carbon monoxide, sulfur oxides, nitrogen oxides, and lead (http://www.epa.gov/air/urbanair/).

### Sulfur Dioxide

SO₂ has absorption features in the same region as the UV portion of the NO₂ spectrum. In particular, the weak tail of the SO₂ spectrum overlaps some of the NO₂ lines of interest. The current EPA standards for SO₂ are:
The annual average cannot exceed 30 ppb
The maximum allowed 24-hour average is 140 ppb (this cannot be exceeded more than once per year).
The daily maximum 1-hour average must not exceed 75 ppb.
The typical average is 10 ppb.

Based on these concentrations, and the cross-sections which are of the order of 1×10⁻²⁴ (cm²/mol) at 405 nm, it is expected that in highly polluted areas the signal from SO₂ in the neighborhood of NO₂ lines around 405 nm will be 3 to 4 orders of magnitude weaker than the NO₂ signal. Thus SO₂ should not cause any measurable interference. See, C. Hermans, A. C. Vandaele, and S. Fally, “Fourier transform measurements of SO₂ absorption cross sections: I. Temperature dependence in the 24000-29000 cm-1 (345-420 nm) region,” J. Quant. Spectrosc, Radiat. Transfer 110, 756-765 (2009); A. C. Vandaele, C. Hermans, and S. Fally, “Fourier transform measurements of SO₂ absorption cross sections: II. Temperature dependence in the 29000-44000 cm-1 (227-345 nm) region,” J. Quant. Spectrosc. Radiat. Transfer 110, 2115-2126 (2009); and National Ambient Air Quality Standards (NAAQS): http://epa.gov/air/criteria.html#11

### Ozone

O₃ has absorption features in the same region as NO₂. In particular, there are extremely strong lines in the UV as well as moderately strong lines in the visible region. A “hole” where the O₃ lines are relatively weak is located between 370 and 450 nm (relatively weak meaning that the cross-section of 10⁻²² cm²/mol is between 2 and 3 orders of magnitude weaker than the strong NO₂ lines in the 400-500 nm range. The current EPA standards for O₃ allow a maximum of 75 ppb for an 8-hour average.

Based on these concentrations, and the cross-sections which are of the order of 7×10⁻²³ cm²/mol, it is expected that in highly polluted areas the signal from O₃ in the neighborhood of NO₂ lines around 405 nm will be 3 orders of magnitude weaker than the NO₂ signal. Thus O₃ should not cause any measurable interference in this region. However, at longer wavelengths such as 450 nm, the O₃ signal from expected concentrations of O₃ climbs to ˜1-5% of the expected NO₂ signal. At longer wavelengths, the cross section of O₃ increases and the NO₂ cross-section decreases until O₃ is within an order of magnitude of NO₂ around 650 nm. See, S. Voigt, J. Orphal, K. Bogumil, and J. P. Burrows, “The temperature dependence (203-293 K) of the absorption cross sections of O₃ in the 230-850 nm region measured by Fourier-transform spectroscopy,” J. Photochem. Photobiol. A: Chem. 143, 1-9 (2001) and National Ambient Air Quality Standards (NAAQS): http://epa.gov/air/criteria.html#11

### Chlorine Dioxide

OClO has strong absorption features in the same region as NO₂. In particular, there are extremely strong lines in the UV region with cross-sections of the order of 1×10⁻¹⁷ cm²/mol at 330 nm as well as moderately strong lines in the visible range (cross-sections on the order of 1×10⁻¹⁸ cm²/mol at 405 nm). The cross-sections for OClO lines in the regions where NO₂ sensor operates (405 nm) are roughly the same as the NO₂ cross-sections. The OSHA limit on atmospheric OClO is currently 100 ppb. This could present a problem with NO₂ detection if the concentrations of OClO are greater than a few ppb. However, OClO is very reactive, and it is unclear whether there would be any meaningful concentrations in ambient air. See, A. Wahner, G. S Tyndall, and A. R. Ravishankara, “Absorption cross sections for OClO as a function of temperature in the wavelength range 240-480 nm,” J. Phys. Chem., 91, 2734-2738 (1987); and Occupational Health Guide for Chlorine Dioxide: http://www.cdc.gov/niosh/docs/81-123/pdfs/0116.pdf

### Laser Source

As discussed in detail above, an NO₂ sensor operating at 405 nm is well suited for atmospheric monitoring of NO₂ and the problems associated with the interference of other atmospheric constituents including trace gases are minimal and can be neglected.

### SUMMARY OF THE INVENTION

The present invention is directed to the development of a sensor for trace gases that can be employed for field based real time monitoring applications. The sensor is designed to be (a) simple, (b) low cost, (c) rugged, (d) able to provide sensitivities at sub ppb level, and (d) operable by non-technical personnel. In order to allow the sensor to be operated by non-technical personnel, complex optical arrangements such as a resonance cavity arrangement or tuning of the laser or an external cavity arrangement for the laser is avoided. There is no modulation of the laser and there is no dithering of the cavity length either. An important feature of the present invention is that it is free from interference from atmospheric water vapor, which is often a severe problem for sensors based on mid-infrared quantum cascade lasers operating for example, in the 1650 cm⁻¹ region.

In the present invention, a broad multimode beam of a diode laser is coupled to a high finesse optical cavity containing the species of interest and a low noise high sensitivity photon detector is used to measure the absorption spectra of the species by employing multiple line integrated absorption spectroscopy (MLIAS) in an off-axis optical cavity arrangement. The multiple line integrated absorption spectroscopy (MLIAS) was recently proposed by the inventor. See, Gottipaty N Rao and A. Karpf, “Extremely sensitive detection of NO₂ employing off-axis integrated cavity output spectroscopy coupled with multiple-line integrated absorption spectroscopy,” Appl. Opt. 50, 1915-1924 (2011); A. Karpf and G. N. Rao, “Enhanced Sensitivity for the Detection of Trace Gases Using Multiple Line Integrated Absorption Spectroscopy,” Appl. Opt. 48, 5061-5066 (2009); A. Karpf and G. N. Rao, “Enhancement of Trace Gas Detection by Integrating Wavelength Modulated Spectra across Multiple Lines,” Appl. Opt. 49, 1406-1413 (2010); Also, see copending U.S. patent application Ser. No. 12/878,553 filed Sep. 9, 2010 of G. N. Rao entitled “Method and Device for Detection of Trace Gases Using Multiple Line Integrated Absorption Spectroscopy”; copending U.S. patent application Ser. No. 13/025,991 filed Feb. 11, 2011 of G. N. Rao entitled “Method and Apparatus for Trace Gas Detection Using Integrated Wavelength Modulated Spectra Across Multiple Lines”; and copending U.S. patent application Ser. No. 13/026,011 filed Feb. 11, 2011 of G. N. Rao entitled “Method and Apparatus for Trace Gas Detection Using Off-Axis Cavity and Multiple Line Integrated Spectroscopy.” Further, see J. B. Paul, L. Lapson, and J. G. Anderson, “Ultrasensitive absorption spectroscopy with a high-finesse optical cavity and off-axis alignment,” Appl. Opt. 40, 4904-4910 (2001).

In the MLIAS recently proposed by the inventor, instead of monitoring a single absorption peak as is traditionally done, the laser is scanned over a large number of molecular transitions and the sum of the areas of all the absorption peaks (after subtracting the background) is used for sensitivity measurements. However, in the arrangement of the present invention, a diode laser operating multimode with large energy spread is used (with no laser scanning) so that multiple transitions of the molecular species are simultaneously excited and the absorption spectra of multiple lines recorded simultaneously. Employing this method, the sensitivity of detection is significantly enhanced.

In the proposed new invention, MLIAS is coupled with off axis cavity integrated spectroscopy to obtain good sensitivity of detection and good stability of performance. This arrangement is not sensitive to vibrations and does not require high precision resonance cavity adjustments.

By using a broad multimode diode laser beam having an energy spread of about 2-4 nm at the base of the peak as the input to the optical cavity, several strong absorption features of NO₂ in the 405 nm region are excited. Thus, the arrangement corresponds to multiple beams entering the cavity at different angles of incidence with respect to the axis of the cavity and we perform multiple line integrated absorption spectroscopy (MLIAS). Employing this method significantly improves the sensitivity of detection since the detected signal is a summation of many absorption features.

Diode lasers are quite compact, operate at room temperatures, have large operating lifetimes, require low power levels for operation, provide high output powers (500 mW or more), and can be operated over a wide tunable range employing temperature and/or injection current tuning. They are well suited for trace gas monitoring in real time for field based applications.

With the arrangement of the present invention, a broad beam output from the diode laser is directed into the cavity with minimal beam shaping, and the output of the cavity corresponds to the absorption of the species over several molecular absorption features. Also, the path lengths can be on the order of a few km depending on the reflectivity of the mirrors used. With this technique the laser beam is incident approximately along the axis of the cavity and is not critically adjusted to satisfy the resonance condition of the cavity. Thus the arrangement may be approximated to multiple beams directed into the cavity in an off-axis configuration with the high finesse optical cavity generating a high density of transverse cavity modes. Even though the laser output is approximately matched to the absorption peak of the gas species, the width of the laser beam at the base is quite broad (approximately 2-4 nm) and the intensity spectrum of the laser output as a function of wavelength is not constant, but has many peaks. For the present experiments dithering of the cavity length was not found to be necessary, but may be helpful in some cases to randomize the modes further and record the spectra.

The OA-ICOS technique is particularly attractive for trace gas sensors because the system does not involve the complex cavity locking mechanisms or stringent resonance conditions necessary in CRDS experiments, is less sensitive to vibrations, and does not require high-speed electronics. The off-axis arrangement allows a range of laser input directions compared to a single normal incidence condition that is necessary for cavity resonance condition. Therefore, it offers a certain level of freedom from the severe vibration isolation and cavity alignment requirements of cavity resonance techniques, such as CRDS.

### BRIEF DESCRIPTION OF THE DRAWINGS

The foregoing and other features of the present invention will be more readily apparent from the following detailed description and drawings of an illustrative embodiment of the invention in which:

FIG. 1 is a block diagram of the apparatus for carrying out the present invention;

FIG. 2 is a drawing of the high finesse optical cavity employed in the apparatus of the present invention as shown in FIG. 1; and

FIG. 3 shows the Integrated Signal of the present invention in arbitrary units vs. NO₂ concentration in ppb.

### DESCRIPTION OF AN ILLUSTRATIVE EMBODIMENT OF THE INVENTION

The present invention uses Multiple Line Integrated Absorption Spectroscopy (MLIAS) coupled with Off Axis Cavity Integrated Spectroscopy (OA-ICOS) to obtain good sensitivity of detection and good stability of performance.

### Off-Axis Integrated Cavity Output Spectroscopy (OA-ICOS)

In cavity enhanced absorption spectroscopy techniques, a tunable laser and a high finesse optical cavity are used, and the cavity output is recorded while tuning the laser over the wavelength range of interest. These techniques are known in the literature as integrated cavity output spectroscopy (ICOS) (See, A. O'Keefe, J. J. Scherer, J. B. Paul, “CW Integrated Cavity Output Spectroscopy,” Chem. Phys. Lett., 307, 343-349 (1999)); and cavity enhanced absorption spectroscopy (CEAS) (See R. Engeln, G. Berden, R. Peters, G. Meijer, “Cavity enhanced absorption and cavity enhanced magnetic rotation spectroscopy,” Rev. Sci. Instrum. 69, 3763 (1998)). In Off-Axis ICOS the laser is aligned in an off-axis configuration to create an extremely dense continuum of optical modes within the cavity. See, J. B. Paul, L. Lapson, and J. G. Anderson, “Ultrasensitive absorption spectroscopy with a high-finesse optical cavity and off-axis alignment,” Appl. Opt. 40, 4904-4910 (2001). The continuum of modes allows the cavity transmission spectrum to be averaged more effectively, resulting in a significant improvement in the sensitivity of detection.

In CRDS the optical cavity is carefully aligned such that the TEM₀₀ mode is dominant. This is accomplished by aligning the laser beam so that it coincides with the cavity axis. As the laser is tuned and the resonance condition is satisfied, the cavity output is characterized by sharp spikes separated by the FSR of the cavity; the width of the spike depending on the cavity finesse. In the case of off axis integrated cavity output spectroscopy (OA-ICOS), the laser beam is incident at a small angle with respect to the cavity axis resulting in a large number of cavity modes including TEM₀₀, TEM₀₁, TEM_{O2}, . . . TEMₘₙ. The cavity transmission spectra thus consist of a large number of spikes at frequencies corresponding to the different modes. The intensity of the transmitted peaks depends on the overlap between the laser and the cavity modes. As the modes (TEM get higher, the density of modes increases. In OA-ICOS, the cavity is carefully misaligned such that the density of cavity modes becomes higher and approaches a continuum of modes. Ideally, when a continuum of modes is achieved, the intensity of the light exiting when a laser is tuned should not depend on the laser's frequency. Thus if an absorbing gas species is present in the cavity, the drops in the intensity of light exiting the cavity represent the absorption spectra specific to the species. This results in transmission spectra that correspond to the characteristic absorption lines of the gas species. See, M. L. Silva, D. M. Sonnenfroh, D. I. Rosen, M. G. Allen, A. O'keefe, “Integrated cavity output spectroscopy measurements of nitric oxide levels in breath with a pulsed room-temperature quantum cascade laser,” Appl. Phys, B 81, 705-710 (2005).

A variety of cavity configurations can result in stable off-axis path lengths through a cavity. For a two mirror cavity with spherical mirrors, the arrangement must satisfy the stability condition:

$$0 \leq ( 1 - \frac{L}{{R}_{1}} ) ( 1 - \frac{L}{{R}_{2}} ) < 1 , \qquad ( 1 )$$

where L is the mirror spacing (15 cm). Normally, two spherical mirrors with identical radii of curvatures (R₁=R₂=1 m) are used. See, K. W. Busch, A. Hennequin, and M. A. Busch, “Introduction to Optical Cavities,” in Cavity Ringdown Spectroscopy, (eds.) K. W. Busch and M. A. Busch, American Chemical Society, Washington, D.C., (1999), pp. 20-33.

For a CW laser, under the steady state conditions, the intracavity power may be written as:

$$I = \frac{{I}_{0} {C}_{p } T}{2 ( 1 - R )} ( 1 - {e}^{\frac{- t}{{τ}_{0}}} ) , \qquad ( 2 )$$

where I₀ is the incident laser intensity, Cₚ is the cavity coupling parameter (it has a value between 0 and 1 and can reach 1 for a well matched TEM₀₀ mode), R is the reflectivity of the mirrors (assumed constant for both the mirrors) and T is the transmission coefficient of the mirrors (again assumed constant for both the mirrors). See, J. B. Paul, L. Lapson, and J. G. Anderson, “Ultrasensitive absorption spectroscopy with a high-finesse optical cavity and off-axis alignment,” Appl. Opt. 40, 4904-4910 (2001). From Eq. (2), the steady state intra-cavity intensity is given by:

$$I = \frac{{I}_{0} {C}_{p } T}{2 ( 1 - R )} . \qquad ( 3 )$$

Assuming nearly lossless mirrors (R+T=1), the amount of light leaking through each mirror is:

$${I}_{L} = \frac{{I}_{0} {C}_{p } T}{2} . \qquad ( 4 )$$

where I_{L} is the intensity of the light leaking through a cavity mirror.

When a weakly absorbing medium is placed between the mirrors, R is replaced with an effective reflectivity R′:

R′=Re^{-α(v)L}, (5)

where α(v)L is the absorbance of the medium in the cavity. Equations (4) and (5) show that the absorbance information is contained in the steady state intra-cavity intensity and thus can be measured via the intensity of the light exiting the cavity. The change in the steady state output of the cavity due to the presence of the absorbing species in the cavity may be expressed in the form:

$$\frac{Δ I}{{I}_{0}} = \frac{GA}{1 + GA} , \qquad ( 6 )$$

where A=1−e^{-α(v)L} and G=R/(1−R). Therefore, for weak absorption, the cavity provides a large linear gain in the absorption signal. For trace gas species, GA is <<1. Thus, GA can be neglected in the denominator of Eq. (6), and may be re-written in the form:

$$\frac{{I}_{0} ( v ) - I ( v )}{{I}_{0} ( v )} = \frac{α ( v ) L}{( 1 - R )} . \qquad ( 7 )$$

The relative change in the laser intensity is directly proportional to the absorption coefficient and hence the number density of the trace species. The presence of the (1−R) term in the denominator gives a large enhancement in the signal compared to single pass absorption. In the present invention, a diode laser output with a large energy spread is incident onto the cavity which can be approximated to multiple beams incident in an off-axis cavity arrangement. This results in the generation of continuum of modes in the cavity and the recorded transmitted intensity is related to the absorption of the molecular species inside the cavity.

### Multiple Line Integrated Absorption Spectroscopy (MLIAS)

A diode laser output which has a broad energy spread is used for excitation of the molecular species of interest inside the cavity. The laser excites several absorption features of the molecular species and the transmitted laser intensity is a function of frequency v given by Beer's law:

I(v)=I₀(v)e^{-α(v)L}, (8)

where I₀ is the incident laser intensity corresponding to a frequency v, L is the optical path length, and α(v) is the absorption coefficient at frequency v. In the low concentration regime (where α(v)L≦0.05) Eq. (8) can be approximated as:

I(v)=I₀(v)[1−α(v)L]. (9)

Assuming that α(v)L is small (as is typically the case with trace gas detection), the integrated absorption may be written as:

S=∫α(v)Ldv. (10)

For a single transition, the absorption coefficient α(v)=σ(v)N (where σ(v) is the cross-section and N is the concentration). The cross section depends on the Einstein A coefficients of the levels and the statistical weight factors. The integral is carried out over Doppler and collisional broadened line shape functions. Thus the integrated absorption is proportional to the concentration N. While, each of the absorption peaks is a complex function as detailed above, an experimental parameter S_{T} can be defined which is equal to the number density Nᵢ multiplied by the sum of the areas under the different absorption peaks. Based on this, it can be shown that the sum of the areas of a set of absorption lines varies linearly with concentration, and conducting trace gas detection by integrating over multiple absorption lines can enhance the sensitivity of detection by over one order of magnitude. See A. Karpf and Gottipaty N. Rao, “Enhanced Sensitivity for the Detection of Trace Gases Using Multiple Line Integrated Absorption Spectroscopy,” Applied Optics, 48, 5061-66, (2009). The sum of the areas of multiple absorption lines may be defined as the experimental parameter S_{T} (e.g., this would take into account the optical path length L, the tuning range and other equipment-related factors and as well as the Einstein A coefficients, the statistical weight factors, and the Doppler and the collisional broadened absorption lines) and measured for different concentrations of the target species:

$${S}_{T} = {\sum }_{i} \int {α}_{i} ( v ) L d v . \qquad ( 11 )$$

Here, αᵢ(v) is the absorption coefficient of the ith transition of the target species, and the summation is over all the transitions within the broad range of excitation of the diode laser. Using pre-calibrated reference mixtures of the desired gas, an S_{T} vs. concentration curve can be defined that characterizes a particular apparatus for carrying out the concentration of trace gas species. The unknown concentrations of the species can be identified by recording their S_{T} and identifying their corresponding concentrations on this chart.

This procedure enhances the sensitivity of detection in three ways. The first enhancement is due to the summing of the areas under many spectral lines (which boosts the magnitude of the recorded signal). The second enhancement is from the fact that the integration has the effect of averaging the random components of the noise. Due to the fact that the data is acquired on a continuous basis, the integration time of the data can be chosen depending on the required sensitivity of detection. The sensitivity is further enhanced over standard laser absorption techniques in that it is not limited to working in the low-pressure regime (i.e., there is no need to resolve the lines individually). This procedure is particularly valuable for molecules which have a large number of transitions grouped together.

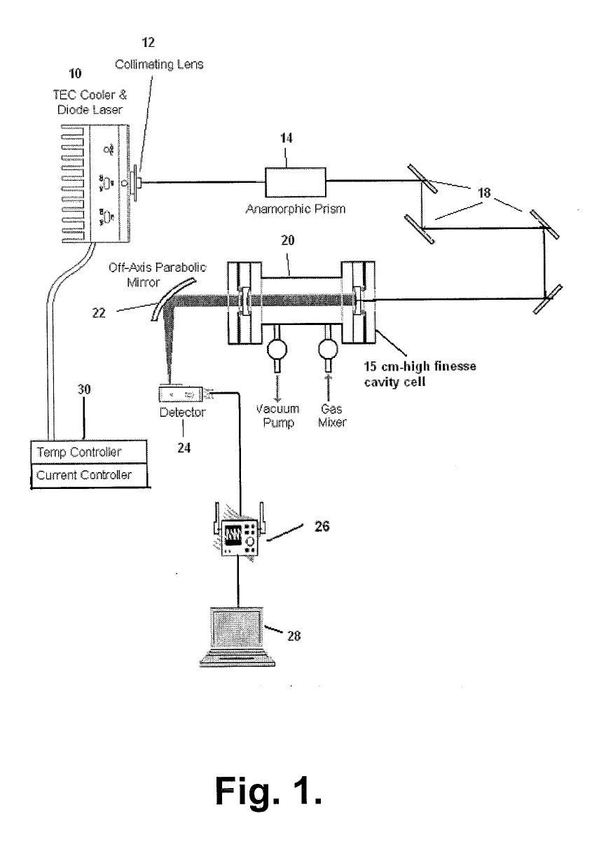

According to the present invention and as shown in FIG. 1, Off-Axis Integrated Cavity Absorption Spectroscopy of NO₂ is carried out using a broad band excitation of a diode laser 10 operating nominally at 405 nm. There are numerous manufacturers and vendors of different types of lasers covering most of the visible region (˜400-760 nm) and the near infrared regions. In particular, high power diode lasers in the violet blue region have become available only recently.

As shown in FIG. 1 the light beam from laser 10 passes through a collimating lens 12 and then through an Anamorphic Prism 14, the output of which is directed on to a series of four high quality reflectors 18. The reflectors cause the beam to enter a high finesse optical cavity cell 20.

### High Finesse Cell

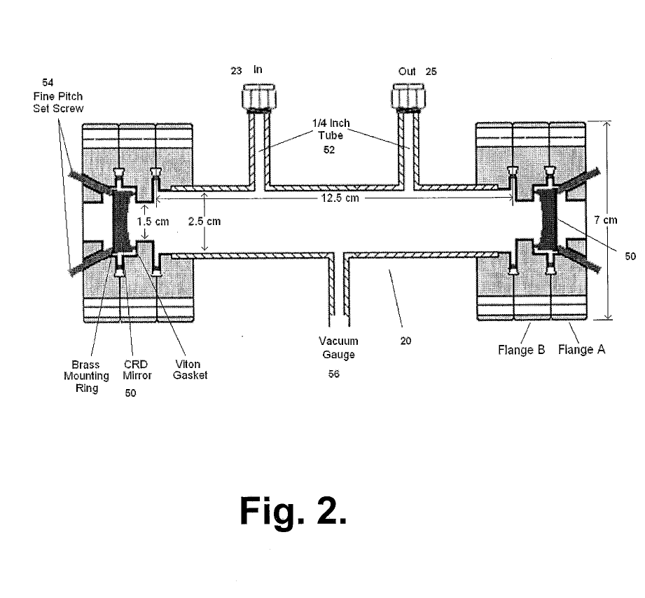

The high finesse cavity cell 20 as shown in more detail in FIG. 2, is typically of 0.15 m length between the mirrors 50 and is designed to have multiple reflections in the cell so that the path length on the order of about 1 km when using mirrors of R=0.9999 reflectivity. With this arrangement the absorption signal is linearly proportional to the concentration of NO₂ at low concentration levels when the laser beam is incident at a small angle to the axis of the cell. The optical cavity is made of stainless steel components coated with Teflon. Teflon coated ¼ inch stainless steel tubing 52 is welded to the cell to allow for the input 23 and exhausting 25 of the sample gases.

### Gas Mixing

A special 2-stage regulator and gas proportioning system is used for the measurements. The system was designed such that achieving concentrations at or below 5 ppb is reliable and is based on the supply of 1 ppm NO₂ from an Airgas cylinder diluted with Zero Air originating from another cylinder. A gas proportioning system was then used to dilute the mixture further, followed by a set of flow control and needle valves to control the flow rate of the mixture into the cell, and control the cell's pressure. The tubing 52 sold by Swagelok that has a smooth Polyethylene Core with Fiber Braid Reinforcement was employed for all the gas connections so that NO₂ absorption/contamination by the exposed metallic parts of the vacuum system is minimized.

The mirrors in the high finesse cavity 20 are positioned with set screws 54. There is also an outlet 56 from the cavity for a vacuum gauge. The dimensions shown in FIG. 2 are for illustrative purposes only and are not to be taken as limits on the scope of the invention.

Upon leaving the cavity 20, the beam is focused by an off axis parabolic reflector 22 on to a low noise detector 24 operating at room temperature. The output signal from the detector 24 is fed to a Tektronix DPO3034 digitizing oscilloscope 26. The oscilloscope output was fed to a PC 28 via USB connection. The signal was recorded using Tektronix oscilloscope software. The data were averaged over 512 scans using an onboard memory of the Tektronix digitizing oscilloscope 26. The scan rate and the number of scans were chosen depending on the speed and sensitivity of detection required. Oscilloscope 26 thus performs the tasks of recording the detector signal, integrating it over the multiple features of the trace gas, and analyzing it to produce an output on its screen which is the concentration of the trace gas of interest.

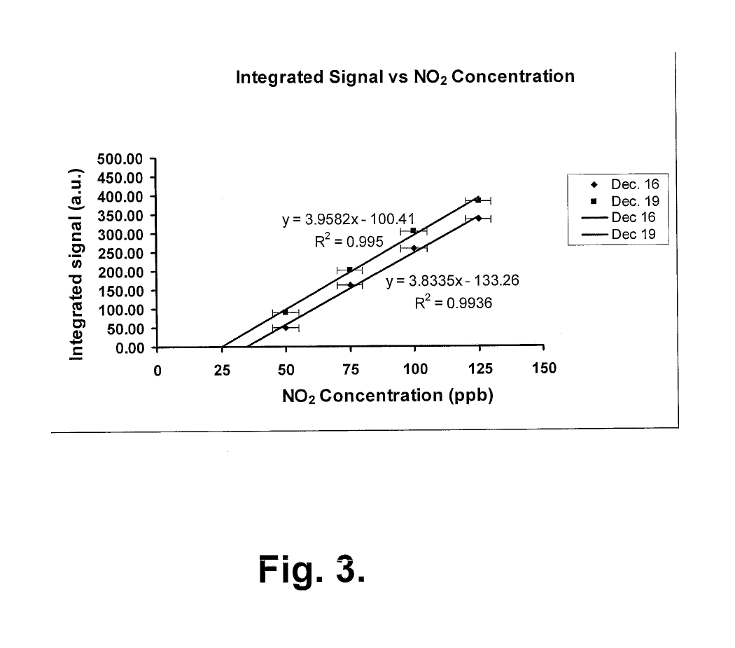

Absorption spectra are recorded for several concentrations of NO₂: The 0 ppb spectrum is recorded to determine the noise contributions from all components of the equipment including any residual contamination of the cell and the vacuum system with NO₂ and the possible degassing of NO₂ from the cell and the vacuum components. The absorption spectra were recorded at 50 ppb, 75 ppb, 100 ppb and 125 ppb NO₂ concentrations. The data from each spectrum are integrated to yield the total absorption strength S_{T} for the corresponding concentration. Each of these values is subtracted from the total absorption strength recorded for the 0 ppm concentration. This corresponds to the total absorption signal for a given concentration. The integrated absorption signal (S_{T}) in arbitrary units vs. NO₂ concentration is plotted in FIG. 3. The standard deviation of the Zero air data is 1.1 arbitrary units. The slope of the least squares fitted straight line to the data from FIG. 3 is 3.958 arbitrary units per ppb NO₂ concentration. From these data the sensitivity for the detection of NO₂ is calculated to be 280 ppt.

In FIG. 3 the plot is of the total absorption signal vs. concentration as well as weighted linear least-squares fit of the data. The slope of the fitted least square fit is used to calculate the sensitivity of detection. The standard deviation of the measurements was calculated using the integrated absorption signal obtained from a set of repeated measurements for zero air. This was accomplished by repeatedly filling the cell with Zero Air, recording the corresponding absorption spectra, determining the integrated absorption signal from these spectra and calculating the standard deviation of the measurements. The standard deviation obtained was used to estimate the uncertainties in the NO₂ concentration. The slope was used to calculate the sensitivity of detection since it included the uncertainties from all the sources related to the measurements (e.g., the errors in preparing the appropriate mixtures of NO₂ and Zero-Air, errors in the NO₂ concentration measurements, etc.). Using these data the sensitivity of the apparatus is determined to be 280 ppt. This sensitivity is adequate for atmospheric monitoring of NO₂ since the concentrations of NO₂ in the atmosphere are in the range 20-100 ppb level depending on the location and proximity to automobile traffic.

Testing of the invention was repeated several times on different days to check for the reproducibility and reliability of the concentration measurements. The concentration measurements data are reproducible within the quoted errors. The data collected on two different days and the observed slopes of the fitted straight lines are shown in FIG. 3 which are in agreement within the quoted errors. This shows that the reproducibility of the concentration measurements employing the sensor is good and the NO₂ contamination and degassing problems even at ppb level are minimal.

For the present experiments, low reflectivity mirrors with a reflectivity of R=0.998 were used and the effective path length for this set of mirrors was approximately 75 m. Additionally, the mirrors used were not of high quality. Using high reflectivity mirrors and the corresponding increase in the path length to about a km or more, it would be expected that the sensitivity of detection could be easily reached well below 100 ppt level.

While the invention has been particularly shown and described with reference to a preferred embodiment thereof, it will be understood by those skilled in the art that various changes in form and details may be made therein without departing from the spirit and scope of the invention.

I claim:

1. A method for detecting trace gases using multiple-line integrated absorption spectroscopy, comprising the steps of:
employing a broad energy laser beam which enters a high finesse optical cavity in an off-axis cavity arrangement containing a sample gas so as to generate a high density of transverse modes, wherein the laser beam exiting the cavity contains information about the absorption spectra of multiple lines of the species of interest;
using an off-axis paraboloidal reflector to direct and focus the laser beam exiting the output of the optical cavity on to a detector that measures the absorption spectra of the species;
recording the absorption spectra from the detector;
integrating the recorded detector signals of the absorption spectra over multiple absorption features of the trace gas; and
analyzing the integrated detector signals to determine the concentration of the trace gas of interest.

2. The method of claim 1 wherein the laser beam output frequency is chosen to match the strong absorption features of the species of interest.

3. The method of claim 1 wherein the laser beam output frequency is tuned to match the strong absorption features of the species of interest.

4. The method of claim 1 wherein the laser is a simple diode laser operating in a single or multimode.

5. The method of claim 1 wherein the laser beam is generated employing one of a cw diode laser, a pulsed diode laser, an external cavity tunable diode laser and variations of the diode laser.

6. The method of claim 5 wherein the variations of the diode laser are one of a distributed feedback diode laser, quantum cascade laser, external cavity tunable quantum cascade laser.

7. The method of claim 1 wherein the laser beam is generated using one of a solid state laser, a gas laser and an OPO (Optical Parametric Oscillator).

8. The method of claim 1 wherein the laser generating the laser beam is tunable or non-tunable with a broad energy spread in the output.

9. The method of claim 1 wherein the laser beam is modulated to improve the transverse modes generated in the cavity, whereby the signal-to-noise ratio is improved, leading to improved sensitivity of detection.

10. The method of claim 1 wherein the laser beam is a pulsed laser beam or a cw laser beam with a beam chopper, and employs phase lock-in detection to improve the signal-to-noise ratio and hence the sensitivity of detection.

11. The method of claim 1 wherein the recorded spectra is in the form of signals that are digitized and displayed.

12. The method of claim 1 further including the step of reading out the signals on a readout device.

13. The method of claim 12 wherein the read out device is one of an oscilloscope, a simple voltage or current meter and an LED/LCD display to directly read the concentration of the species of interest.

14. Apparatus for detecting trace species using multi-line absorption spectroscopy, comprising:
a laser source that generates a broad energy laser beam, wherein the frequency of the laser beam can be matched with the absorption features of the species of interest;
a high finesse optical cell with an off-axis input for receiving the laser beam and fitted with high reflectivity mirrors at the wavelength corresponding to the laser output frequency so as to generate a high density of transverse modes, and wherein the laser beam exiting the cavity contains information about the absorption spectra of multiple lines of the species of interest in the cavity;
an off-axis paraboloidal reflector at the output of the cell arranged so that the laser beam exiting the cavity is focused;
a low noise high gain detector that receives the focused laser beam from the reflector and measures the absorption spectra of the species;
a storage medium for recording the measured absorption spectra from the detector;
an integrator circuit that integrates the recorded detector signals of the absorption spectra over multiple lines of the absorption features of the trace gas; and
analyzer circuit using the integrated detector signals to determine the concentration of the at least one trace gas of interest.

15. The apparatus of claim 14 wherein the storage medium, integrator circuit and analyzer circuit are in an oscilloscope.

16. The apparatus of claim 15 wherein the concentration is displayed on the screen of the oscilloscope.

17. The apparatus of claim 14 wherein the laser is cw or pulsed, such as a diode laser.

18. The apparatus of claim 14 wherein the trace gas is NO₂ and the desired frequency range of the laser is 350-460 nm.
